(19) United States
(12) Patent Application Publication
(10) Pub. No.: US 2008/0143268 A1
(43) Pub. Date: Jun. 19, 2008

(54) Flash light emitting device

(75) Inventors: Tetsuya Torikai, Hyogo (JP); Takafumi Mizojiri, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 12/000,482

(22) Filed: Dec. 13, 2007

(30) Foreign Application Priority Data
Dec. 13, 2006 (JP) 2006-335267

(51) Int. Cl. H05B 41/36

(52) U.S. Cl. 315/195

(57) ABSTRACT

A flash light emitting device that irradiates flash light to a work piece, comprises a first flash light discharge lamp and a second flash light discharge lamp. In the flash light emitting device, a time width of a second flash light discharge lamp current is shorter than a time width of a first flash light discharge lamp current, and the second flash light discharge lamp current is inputted into the second flash light discharge lamp after the first flash light discharge lamp current is inputted into the first flash light discharge lamp.

### CROSS-REFERENCES TO RELATED APPLICATION

This application claims priority from Japanese Patent Application Serial No. 2006-335267 filed on Dec. 13, 2006, the contents of which are incorporated herein by reference in its entirety.

### TECHNICAL FIELD

Described herein is a flash light emitting device suitably used as a heat source for heat-treating a work piece, for example, a semiconductor wafer.

### BACKGROUND

In recent years, in a light heating apparatus for heat-treating a work piece such as a semiconductor wafer, it is required that a surface portion of the semiconductor wafer be heated to a predetermined temperature in an extremely short time. Use of the flash light emitting device equipped with the flash light discharge lamp as a source for heating has been examined.

A semiconductor wafer having a 100 mm to 300 mm diameter, is mainly used as such a work piece. It is very difficult to raise the temperature of the work piece having such a large face to be processed in a short time to a predetermined temperature by one flash light discharge lamp at high uniformity. Therefore, a flash light discharge device having a flash light discharge lamps and a reflector shared by these discharge lamps is used therefor. In the flash light discharge device, two or more flash light discharge lamps are arranged in parallel at equal intervals according to the size of the work piece.

FIG. 16 is a cross-sectional view of a light heating apparatus disclosed in Japanese Laid Open Patent No. 2002-198322, which is used as a light heating apparatus having a conventional flash light discharge device. The light heating apparatus for heat-treating a work piece 2 is equipped with a chamber 4 having an atmosphere gas introducing port 41, a flash light discharge device 1, and a preheating unit 3. Inside the chamber 4, the work piece 2 is put on a support stand (not shown), and light is irradiated to the work piece 2 through a quartz window 43, whereby the work piece 2 is heat-treated.

The flash light discharge device 1 is equipped with two or more rod-shaped flash light discharge lamps 10 arranged in parallel to one another at equal intervals, and a reflector 11 shared by these flash light discharge lamps 10.

The preheating unit 3 is equipped with two or more rod-shaped halogen lamps 31 arranged in parallel to each other at equal intervals, and a reflector 32 shared by these halogen lamps 31.

Such a light heating apparatus turns on the halogen lamps 31 corresponding to the preheating unit 3 beforehand, whereby the work piece 2 is preheated to a temperature at which thermal diffusion of the impurities introduced in the work piece 2 does not occur. Then, the flash light discharge device 1 is operated, so that flash light is emitted to the work piece 2, and heat treatment is performed thereon.

### BACKGROUND

Currently, the flash light discharge lamps 10 which are operated by using pulse current with a time width of approximately 1 msec, are used for heat treatment of such a work piece 2. However, since in order to cope with demands of refinement in a manufacturing process of the semiconductor integrated circuit, it is desired that flash light be irradiated to the work piece 2, using the flash light discharge lamps 10 with a shorter time width of pulse current. However, in order to shorten the time width of the pulse current of the flash light discharge lamps 10 when heating the work piece 2 to a predetermined processing temperature, the peak value of the pulse current must be raised. In such a case, excessive load is applied to the flash light discharge lamps 10, and the life span of the flash light discharge lamps 10 becomes remarkably short. On the other hand, the work piece 2 may be preheated so as to rise the temperature of the work piece 2 higher than that of the conventional one by the preheating unit 3 so that the difference between a preheating temperature and a processing temperature is made small, and the insufficiency of the flash light irradiated from the flash light discharge device 1 is compensated. However, if the work piece 2 is maintained at a temperature higher than that of the conventional one, the thermal diffusion of the impurities introduced into the work piece 2 may occur. Therefore, in the conventional device, the work piece 2 cannot be heat-treated by shortening the time width of the pulse current of the flash light discharge lamps 10 within the limit of possible preheating temperature.

### SUMMARY

Description of a flash light emitting device capable of shortening a time width of pulse current of a flash light discharge lamp(s), thereby heat-treating the surface of a work piece is will be given below. The “time width” of the pulse current means so-called “half width” or “half bandwidth”, that is, a period during which more than the half the peak value of the pulse current is added to a discharge lamp(s).

The flash light emitting device that irradiates flash light to a work piece, comprises a first flash light discharge lamp(s) and a second flash light discharge lamp(s), wherein a time width of a second flash light discharge lamp current is shorter than a time width of a first flash light discharge lamp current, and the second flash light discharge lamp current is inputted into the second flash light discharge lamp(s) after the first flash light discharge lamp current is inputted into the first flash light discharge lamp(s).

In the flash light emitting device, a peak value of the second flash light discharge lamp current may exist in a period in which the first flash light discharge lamp current decreases from a peak value thereof to zero.

In the flash light emitting device, the first flash light discharge lamp current may be shut down compulsorily, and the second flash light discharge lamp current may be inputted before the first flash light lamp current turns into zero.

Moreover, in the flash light emitting device, two or more of the first flash light discharge lamps may be arranged in a shape of plane, and two or more of the second flash light discharge lamps may be arranged in a shape of plane between the first flash light discharge lamps and the work piece.

Further, a flash light discharge device according to an embodiment has a first flash light discharge lamp(s) and a second flash light discharge lamp(s), wherein a time width of current of the second flash light discharge lamp(s) may be half of the time width of current of the first flash light discharge lamp(s) or shorter. Since the current of the second discharge lamp(s) is inputted after the current of the first flash light discharge lamp(s) is inputted, the surface of the work piece can be heat-treated only for a short time, to a processing temperature or more.

### BRIEF DESCRIPTION OF DRAWINGS

Other features and advantages of the present flash light emitting device will be apparent from the ensuing description, taken in conjunction with the accompanying drawings, in which:

FIG. 1 is an explanatory cross sectional view showing the structure of a light heating apparatus;

FIG. 2 is an explanatory diagram showing the structure of a flash light discharge lamp;

FIGS. 3A and 3B are explanatory diagrams showing the lighting circuit of a flash light discharge lamp(s);

FIG. 4 is a graph showing a waveform A of pulse current whose time width is 0.2 msec;

FIG. 5 is a graph showing a waveform B of pulse current whose time width is 1.0 msec and the surface temperature T₁ of a work piece;

FIG. 6 is a graph showing pulse current A, pulse current B and the surface temperature T₂ of a work piece;

FIG. 7 is a graph showing a waveform B of pulse current which is shut down compulsorily, and the surface temperature T1 of a work piece;

FIG. 8 is a graph showing an irradiation energy distribution from discharge lamps to a work piece;

FIG. 9 is a graph showing an irradiation energy distribution from discharge lamps to a work piece;

FIG. 10 is a circuit diagram of a lighting circuit;

FIG. 11 is a timing chart of a lighting circuit;

FIG. 12 is a circuit diagram of a lighting circuit;

FIG. 13 is a timing chart of a lighting circuit;

FIG. 14 is a circuit diagram of a lighting circuit;

FIG. 15 is a timing chart of a lighting circuit; and

FIG. 16 is a view showing the structure of a light heating apparatus.

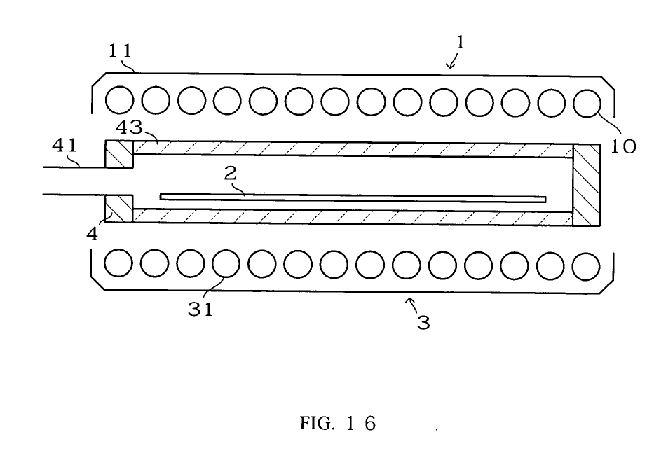

### DETAILED DESCRIPTION

A description will now be given, referring to embodiments of the present flash light emitting device. While the claims are not limited to such embodiments, an appreciation of various aspects of the present flash lamp emitting device is best gained through a discussion of various examples thereof.

In such embodiments, a flash light discharge lamp(s) 10 with a shorter time width of pulse current, is used to irradiate a flash light to a work piece 2, in order to expose a microscopic circuit.

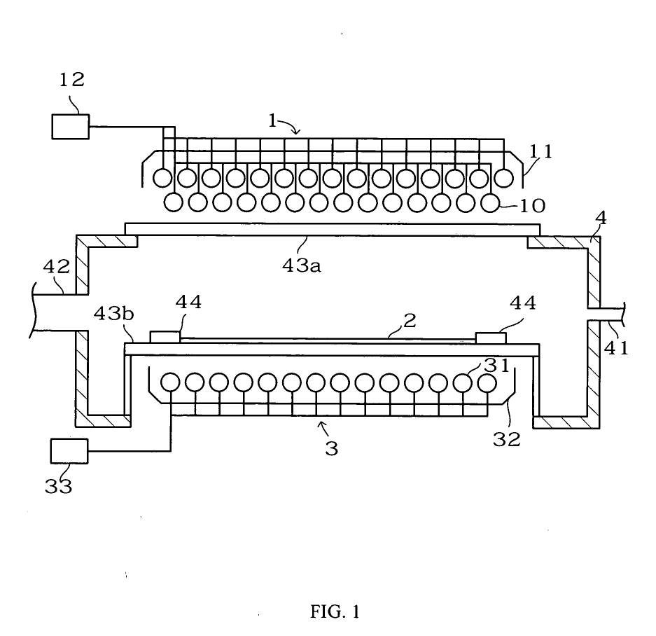

FIG. 1 is an explanatory cross sectional view showing the structure of a light heating apparatus. The light heating apparatus is used to heat-treat a work piece 2. The work piece 2 is a semiconductor wafer in which, for example, impurity ions are introduced, and heat treatment is carried out by heating only the surface of the wafer. It is effective in heat treatment of a circuit or wiring which is made of heat-resistant low material and which is especially formed in the back face of the work piece 2 to be irradiated. For example, there is a heat treatment of a power semiconductor device on which a circuit or wiring is formed in the back face, and especially a heat treatment of an IGBT (insulated gate bipolar transistor). The light heating apparatus is equipped with a chamber 4 which has an atmosphere gas introducing port 41 and a work piece entrance 42, and a support stand 44 for supporting the work piece 2, arranged in the chamber 44. Moreover, a first quartz window 43a made from a quartz plate is provided in a ceiling face of the chamber 4, and a second quartz window 43b made from a quartz plate is provided at a bottom of the chamber 4. A preheating unit 3 is provided under the second quartz window 43b, and a flash light discharge device 1 is provided above the first quartz window 43a as a heating source. Here, the preheating unit 3 is equipped with two or more rod-shaped halogen lamps 31 arranged in parallel to one another at equal intervals along with the second quartz window 43b, a reflector 32 which is shared by these halogen lamps 31, and a halogen lamp lighting circuit 33 for controlling an operation of each halogen lamp 31. Moreover, the flash light discharge device 1 is equipped with two or more rod-shaped flash light discharge lamps 10 arranged in parallel to one another at equal intervals along with the first quartz window 43a, a reflector 11 which is shared by these flash light discharge lamps 10, and a flash light discharge lamp lighting circuit 12 for controlling an operation of each flash light discharge lamp 10.

In such a light heating apparatus, after all the halogen lamps 31 of the preheating unit 3 are turned on so as to be in a lighting state at the same time, thereby preheating the work piece 2 to raise it to a preheating temperature at which thermal diffusion of introduced impurities does not occur, the flash light discharge device 1 is operated so that flash light is emitted to the work piece 2 thereby carrying out the heat treatment. Thus, by carrying out the preheating, a difference between the temperature of the front face and that of the back face of the work piece 2 can be made small, so that the thermal stress of the work piece 2 can be eased, and cracks of the work piece 2 can be prevented. Speaking concretely, if the preheating is not carried out, when the temperature of the surface of the work piece 2 reaches 1000 degrees Celsius momentarily, since the back face of the work piece 2 is a room temperature (30 degrees Celsius), the difference between the temperature of the front face and that of the back face of the work piece 2 becomes 970 degrees Celsius. However, if the preheating is carried out, since the work piece 2 is beforehand heated at, for example, 300 degrees C., the difference between the temperature of the front face and that of the back face of the work piece 2 can be held down to 700 degrees Celsius. In addition, the work piece 2 can also be heat-treated, without carrying out preheating.

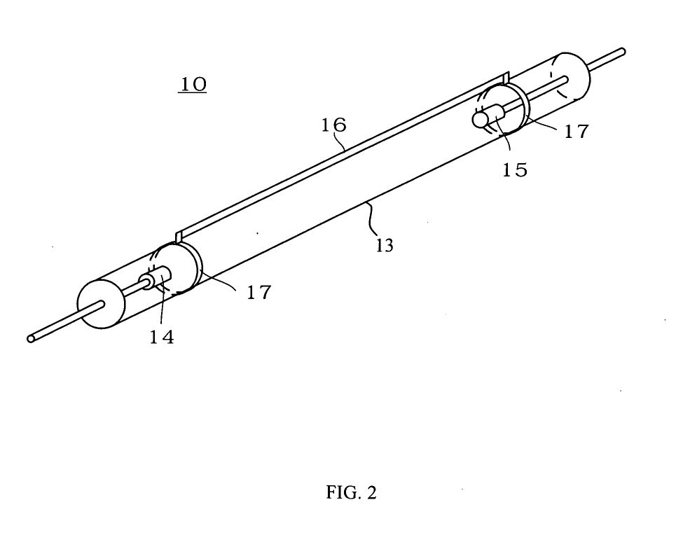

FIG. 2 is a diagram showing the structure of one of the flash light discharge lamps 10 according to an embodiment. For example, xenon gas is enclosed in each flash light discharge lamp 10 and both ends thereof are sealed. The flash lamp discharge lamp has a straight pipe type discharge container 13 made of quartz glass or sapphire, in which an electrical discharge space is formed, and an electrodes 14 and 15 which face each other in the electrical discharge space. Moreover, a trigger line 16 is disposed along with the exterior surface of the electric discharge container 13 so as to extend in a direction of a tube axis (the longitudinal direction of the container) in order to improve a lamp starting nature. The trigger line 16 is made of metal, such as nickel, and an outer diameter thereof is 1 mm. The trigger line 16 is disposed in the tube axis direction along with the outer wall of the arc tube, so as to extend from neighborhood of the electrode 14 to neighborhood of the other electrode 15, and then is fixed with trigger bands 17. When high voltage, for example, about a dozen of kilovolts is impressed to the trigger line 16, an electric field is induced in the axis direction along with the inner wall of the arc tube, whereby the induction of the electric field serves as a trigger, so as to cause electric discharge between the both electrodes, and therefore flash light is emitted. In addition, without providing the trigger line 16, the high voltage more than a breakdown voltage can be impressed between the electrodes of the flash light discharge lamp 10, so that electric discharge can be initiated.

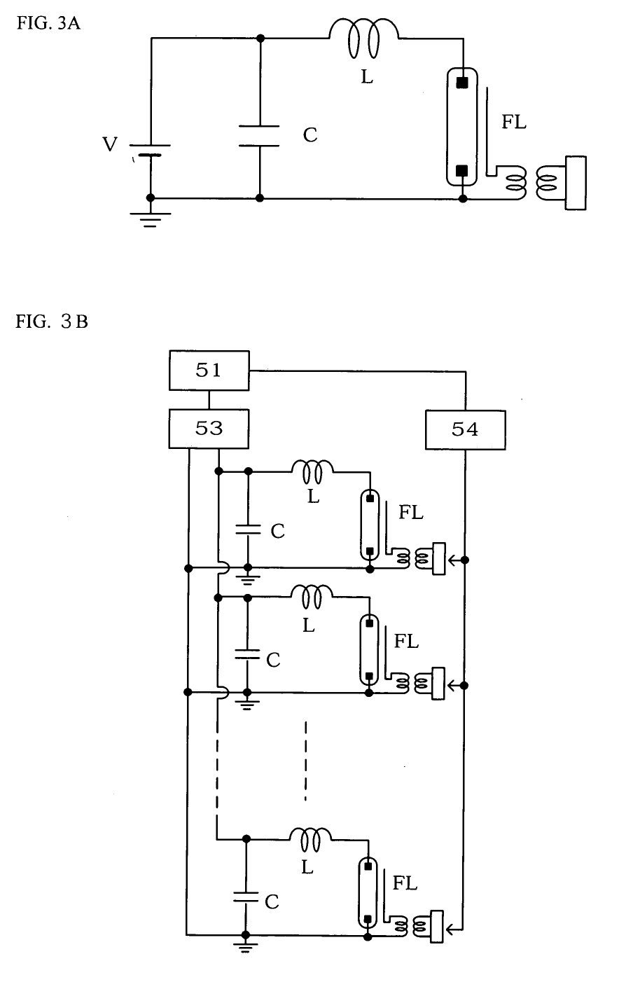

FIGS. 3A and 3B are diagrams showing a lighting circuit of the flash light discharge lamp(s) FL according to an embodiment. Specifically, FIG. 3A shows a lighting circuit for a flash lamp discharge lamp FL, and FIG. 3B is a lighting circuit for two or more flash light discharge lamps FL. Pulse current with a short time width is inputted into the flash light discharge lamp(s) FL as an energy source in order to cause discharge momentarily. As shown in FIG. 3A, the lighting circuit of the flash light discharge lamp FL consists of a capacitor, a coil, a trigger generating circuit, and a boosting transformer. The time width and the amount of energy of the pulse current can be adjusted according to the capacitance C of the capacitor, the inductance L of the coil, and a value of the charge voltage V. Generally, the time width of pulse current depends on the value (LC) obtained from the capacitance C of the capacitor and the inductance L of the coil, and the amount of energy of the pulse current depends on a value (CV²) obtained from the capacitance C of the capacitor and the charge voltage V. For example, if the inductance L of the coil and the charge voltage V are increased, the time width of the pulse current becomes long and the pulse current will have a waveform with a large amount of energy. If the capacitance C of the capacitor is made small, pulse current will have a short time width and the waveform showing a small amount of energy.

The waveform of the pulse current is influenced by the wiring length (resistance), and the size and radiant energy (impedance) of the flash light discharge lamp FL. According to situations, the capacitor C of the capacitor, the inductance L of the coil, and the charge voltage V are adjusted, so as to determine the waveform of the pulse current.

Moreover, a semiconductor switch can be inserted in the middle of the electric discharge circuit, so that the timing of a lighting start and an end of the lighting can also be controlled. The electric discharge is compulsorily terminated at arbitrary time by the switch so as to adjust the time width of the pulse current.

The lighting circuit shown in FIG. 3A is connected to each of the two or more flash light discharge lamps FL as shown in FIG. 3B, and a charger 53 for supplying charge voltage V, which is shared by these lamps is connected thereto. A control unit 51 operates the charger 53 and a lighting signal generating section 54, and a common drive signal is inputted into the lighting circuit from the lighting signal generating section 54.

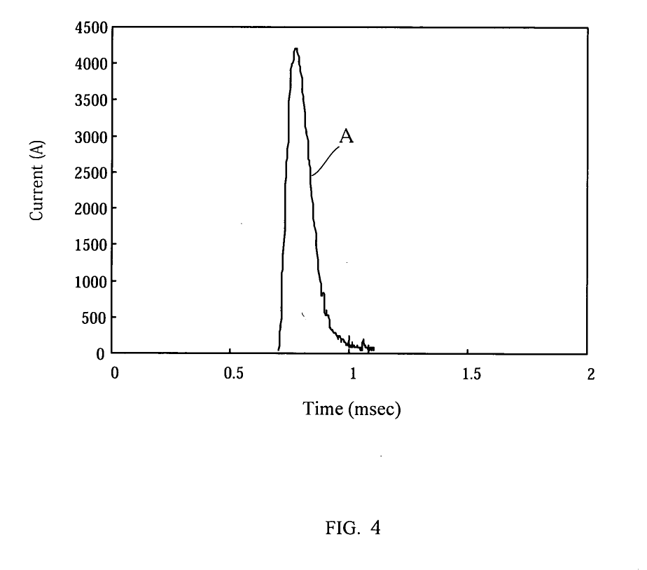

FIG. 4 is a graph showing a waveform of the pulse current A of a 0.1 msec time width, which is inputted into one of the flash light discharge lamps 10, where the horizontal axis shows time (msec) and the vertical axis shows current (A). In order to cope with the refinement demands in a manufacturing process of a semiconductor integrated circuit, it is desired that flash light be irradiated to the work piece 2, using the flash light discharge lamp(s) 10 in which the time width of pulse current A is 1 msec or less, preferably 0.0001 msec to 0.3 msec. Since, in the flash light discharge lamp(s) 10 which uses pulse current with a short time width, the work piece 2 can be heated in a moment, the thermal diffusion of the work piece 2 is generally hard to occur, even if the amount of energy inputted by pulse current decreases, the face of the work piece 2 can be heated to a predetermined temperature. However, in the flash light discharge lamp(s) 10, in order to secure the amount of energy for heating the work piece 2 to the predetermined temperature with the pulse current A whose time width is shortened to 1 msec or less, the peak value of the pulse current A needs to be very high. If the peak value becomes high like the pulse current A, a thermal load will be applied to the inner surface of the electric discharge container 13 of the flash light discharge lamp(s) 10. If the lamp is lighted several hundred times, it will not be able to bear the thermal load so that the electric discharge container(s) 13 is deteriorated. In addition, the “time width” of the pulse current means a period during which more than the half the peak value of the pulse current is added to the current.

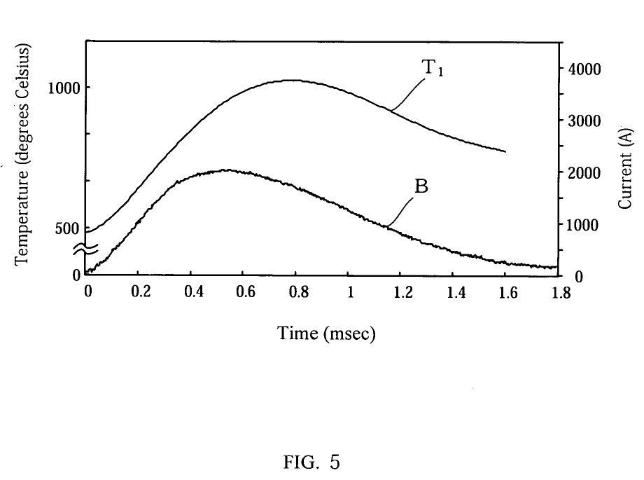

FIG. 5 shows a waveform B of the pulse current with a 1.0 msec time width, which is inputted into one of the flash light discharge lamps 10, where the horizontal axis shows time (msec), the right vertical axis showing current (A), and the left vertical axis showing temperature (degree Celsius). In the figure, a surface temperature T, of the work piece 2 heated by the flash light of the flash light discharge lamp(s) 10 to which the pulse current B is inputted, is shown. Since the peak value of the pulse current B with a long time width does not become too large even if the inputted amount of energy for heating the work piece 2 to a predetermined processing temperature is secured, the flash light discharge lamp(s) 10 into which the pulse current B with a long time width is inputted has a comparatively small thermal load to the electric discharge container 13. Moreover, since the time width of the pulse current B is shorter than that applied by the preheating unit 3, even if the work piece 2 is heated to the preheating temperature or more, the thermal diffusion of the impurities introduced into the work piece 2 does not occur. Moreover, the surface temperature T1 of the work piece 2 does not quickly change in response to a change of the waveform B of the pulse current. The work piece 2 is heated slightly later than application of the waveform B of the pulse current thereto after the preheating temperature becomes 450 degrees Celsius which is maintained by the preheating unit 3. It turns out that the surface temperature T1 of the work piece 2 is high in a period during which the pulse current B decreases from the peak value thereof to zero (0). Then, in order to solve the above described problem in case where the work piece 2 is irradiated, using the flash light discharge lamp(s) 10 with a shorter time width of pulse current, in the embodiment, the flash light discharge lamp(s) 10 are turned on in which, the heating insufficiency of the work piece 2 by the flash light discharge lamp(s) 10 into which pulse current A with a short time width is inputted, may be compensated by inputting the pulse current B with a long time width into the flash light discharge lamp(s) 10. That is, the surface temperature of the work piece 2 is raised to approximately the processing temperature by the first flash light discharge lamp(s) 10b into which the pulse current B with long time width is inputted, and short-time heating is carried out only for part insufficient for the processing temperature, by the second flash light discharge lamp(s) 10a into which the pulse current A with a short time width is inputted. Since the input amount of energy of pulse current A with a short time width is small while the surface of the work piece 2 can be heated for only a short time so that the temperature thereof may be raised to the processing temperature or more, the peak value of the pulse current A with a short time width can be decreased, and the thermal load to the electric discharge container 13 can be reduced (suppressed), whereby the life span of the flash light discharge lamp(s) 10 can be prolonged.

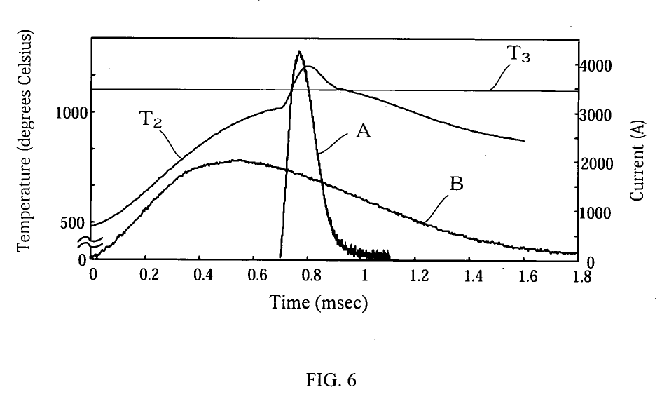

FIG. 6 shows the waveform A of the pulse current of a 0.1 msec time width, which is inputted into each of the flash light discharge lamps 10, and the waveform B of the pulse current of a 1.0 msec time width, which is inputted into each of the flash light discharge lamps 10, where the horizontal axis shows time, the right vertical axis showing pulse current, and the left vertical axis showing temperature. In the figure, a surface temperature T₂ of the work piece 2 heated by flash lights emitted from thirty (30) second flash light discharge lamp(s) 10a to which the pulse current A is inputted, and twenty nine (29) first flash light discharge lamp(s) 10b to which the pulse current B is inputted, is shown. By the first flash light discharge lamp(s) 10b into which the pulse current B with a long time width is inputted, the surface temperature T₂ of the work piece 2 is raised to about the processing temperature T₃. By the second flash light discharge lamp(s) 10a into which the pulse current A with a short time width is inputted, short-time heating is carried out for only part insufficient for the processing temperature T₃. Thus, since the work piece 2 is heated to the processing temperature T₃ or more for only a short time even if flash light is separately irradiated in two steps to the work piece 2, similarly to the case where the amount of energy capable of rising the surface temperature of the work piece 2 to the processing temperature T₃ is inputted into the flash light discharge lamp(s) by only the pulse current A, it is also possible to rise the surface temperature of the work piece 2 for only a short time to the processing temperature T₃ in this case. That is, it is possible to heat the work piece 3 so that the temperature thereof can be raised to the processing temperature T₃ (1,100 degrees Celsius) or more for only 0.2 msec thereby remarkably reducing the processing time, compared with 1 msec which is the conventional processing time. Moreover, since by the first flash light discharge lamp(s) 10b into which the pulse current B with a long time width is inputted, short-time heating of the work piece 2 is further carried out in the state where the surface temperature T₂ of the work piece 2 is raised beforehand to about the processing temperature T₃, a difference between the temperature of the front face and that of the back face of the work piece 2 can be reduced, and cracks which may occur in the work piece 2 can be reduced, thereby preventing breaks of the work piece 2.

In the flash light discharge lamp(s) 10 into which the pulse current A with a short time width is inputted, the shorter the time width of the pulse current A is, the shorter it takes to heat the surface of the work piece 2 to the processing temperature or more. On the contrary, when the time width of the pulse current A and the time width of the pulse current B with a long time width are almost the same, the effect of superposed light emission in a time shift manner can be hardly expected, and the effect is almost the same as that in case of light emission only by the flash light discharge lamp(s) 10 into which the pulse current B with the time width is inputted. In such a case, since the circuit which controls timing of lighting becomes rather complicated, the cost thereof goes up so that it is disadvantageous. Therefore, the short time width of the pulse current A is desirably half of the long time width of the pulse current B, or shorter. Moreover, the time width of the pulse current A is 1 msec (millisecond) or less, and especially if it is 0.3 msec or less, it is possible to expose microscopic circuits which could not be processed by the conventional flash light discharge device. On the other hand, in the flash light discharge lamp(s) 10, it takes least 0.0001 msec or more to start lighting and to generate electric discharge. As mentioned above, the short time width Tw of the pulse current A is desirably half of the long time width of the pulse current B, and 0.0001 msec ≦Tw≦1 msec (0.0001 msec or more and 1 msec or less), and preferably 0.3 msec or less.

The flash light discharge lamp(s) 10 into which the pulse current B with a long time width is inputted heats the work piece 2 to a temperature higher than the preheating temperature. If the work piece 2 is maintained at a temperature higher than the preheating temperature for 500 msec or more, diffusion of ions introduced into the work piece 2 occurs. Therefore, the time width of the pulse current B may have to be set to 500 msec or less. Moreover, if the work piece 2 is heat-treated by the flash light discharge lamp(s) 10 into which the pulse current of a time width shorter than 1 msec is inputted, in order to secure the input amount of energy by which can heat the work piece to the predetermined temperature, the peak value of the pulse current B may have to be raised very high. If the peak value of the pulse current B becomes high, the electric discharge container 13 of the flash light discharge lamp(s) 10 cannot endure the thermal load applied to the inner surface thereof, thereby causing deterioration. Especially, in case where the time width of the pulse current B is set to 0.3 msec or less, when the amount of energy for heating the surface of the work piece 2 to approximately the processing temperature T₃ is secured, even if the number of flash light discharge lamp(s) 10 etc. is increased, the thermal load of the electric discharge container 13 becomes large, so that the life span of the flash light discharge lamps 10 becomes very short, whereby it cannot be practically used. As mentioned above, the long time width of the pulse current B is set to 0.3 msec or more, and preferably set to 1 msec or more, and 500 msec or less.

The timing of lighting of the first flash light discharge lamp(s) 10b into which the pulse current B with a long time width is inputted and the timing of lighting of the second flash light discharge lamp(s) 10 into which the pulse current A with a short time width is inputted are very important. While the first flash light discharge lamp(s) 10b into which the pulse current B with a long time width is inputted, has not raised the surface of the work piece 2 to approximately the processing temperature, if the second flash light discharge lamp(s) 10a into which the pulse current A with a short time width is inputted is lighted, the surface of the work piece 2 may not be raised to the processing temperature. Therefore, as shown in FIG. 5, while the pulse current B of the first flash light discharge lamp(s) 10b decreases from the peak value thereof to zero (0), that is, in a period when the surface temperature T₂ of the work piece 2 rises, it may be necessary to light the second flash light discharge lamp(s) 10a into which the pulse current A with a short time width is inputted. In addition, in order to raise rapidly the surface temperature T₂ of the work piece 2 by the second flash light discharge lamp(s) 10a, the peak value of the pulse current A inputted into the second flash light discharge lamp(s) 10a, is desirably larger than the peak value of the pulse current B inputted into the second flash light discharge lamp(s) 10b.

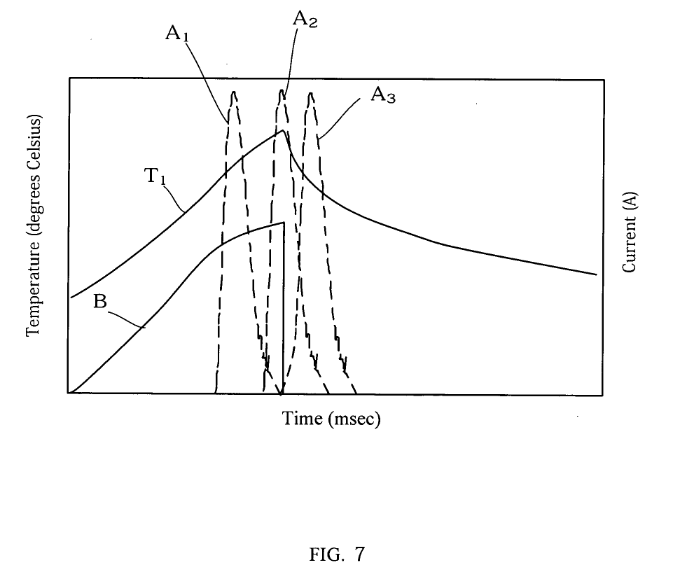

However, since the waveform of the pulse current B and that of the temperature of the work piece 2 differ from each other (in their relation) when the pulse current B with the long time width is compulsorily shut down by a switch etc., the lighting timing of the first flash light discharge lamp(s) 10b into which the pulse current B with a long time width is inputted, and that of the second flash light discharge lamp(s) 10a into which the pulse current A with a short time width is inputted also differ from each other. FIG. 7 is a graph showing pulse currents A₁, A₂, and A₃, in which the pulse current B is compulsorily shut down by the switch etc. and the surface temperature T₁ of the work piece 2 heated by the flash light discharge lamp(s) 10 into which the pulse current B is inputted. The pulse current B is shut down compulsorily and turns into zero (0) before the pulse current B reaches the peak value. On the other hand, although the surface temperature T₁ of the work piece 2 is heated smoothly, and then the pulse current B reaches the peak value so that the surface temperature T₁ turns into the maximum temperature, and then the temperature drops rapidly after that. The waveform of the surface temperature T₁ of the work piece 2 is approximately symmetrical with respect to the time of shut down of the pulse current B. Therefore, in a period during which the surface temperature T₁ of the work piece 2 is rising, it is desirable that the pulse current B of the first flash light discharge lamp(s) 10b reaches approximately the peak value, and during that period, the second flash light discharge lamp(s) 10a into which the pulse current A with a short time width is inputted is turned on for superposition. Since the pulse current A₁ is inputted well before the pulse current B is shut down, the pulse current A₁ reaches the peak value thereof before the pulse current B is shut down. Since an input of the pulse current A₂ begins approximately at the time of shut down of the pulse current B, the timing of the peak value of the pulse current A₂ and that of the peak value of the pulse current B are matched each other. Since an input of the pulse current A₃ begins immediately after the shut down of the pulse current B, the pulse current A₃ reaches the peak value thereof after the shut down of the pulse current B. That is, if the input of the pulse current A of the second flash light discharge lamp(s) 10a begins before the pulse current B of the first flash light discharge lamp(s) 10b reaches zero (0), light from the second flash light discharge lamp(s) 10a can be superimposed thereon while the surface temperature of the work piece 2 is high, so that the surface temperature of the work piece 2 can be raised to the processing temperature. If the flash light discharge device according to the embodiment is used for heat processing of gates, an emitter circuit and/or wiring, it is possible to heat-process the surface of the work piece 2 without producing heat damages to the gates, emitter circuit and/or wiring which are formed in the back side of the work piece 2, so that, for example, an activation processing of PN joints which are formed in the collector side thereof can be performed.

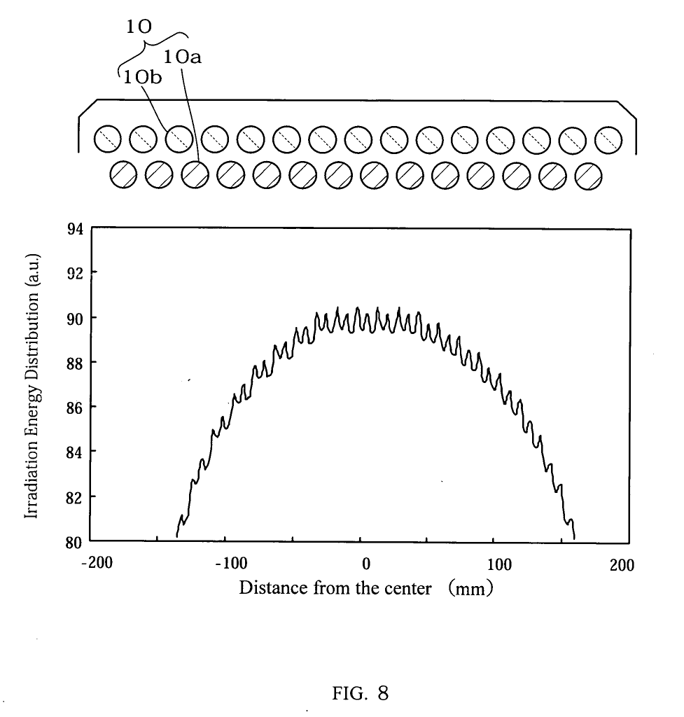

FIG. 8 is a diagram showing an irradiation energy distribution in case where the two or more first flash light discharge lamps 10b into which the pulse current B with a long time width is inputted, are in parallel arranged, and the two or more second flash light discharge lamps 10a into which the pulse current A with a short time width is inputted, are arranged in the side of the work piece 2. Each of the first flash light discharge lamps 10b comprises an electric discharge container 13 made of quartz glass, and each of the second flash light discharge lamps 10a comprises an electric discharge container 13 made of sapphire. This is because quartz glass can withstand a thermal shock, and the thermal resistance of sapphire is high. Since the thermal shock generated in the electric discharge container 13 becomes large as in the case of the pulse current B with a long time width in which the amount of energy inputted to the flash light discharge lamps 10 is large, it is desirable to use the electric discharge container 13 made of quartz glass. On the other hand, when the peak value of the pulse current inputted into the flash light discharge lamps 10 like the pulse current A with a short time width is high, since the temperature of the electric discharge container 13 becomes high, it is desirable to use the electric discharge container 13 made of sapphire.

The two or more first flash light discharge lamps 10b into which the pulse current B with a long time width is inputted are arranged in the shape of a plane in parallel with the work piece 2, and emits flash light radiation uniformly onto the work piece 2, thereby raising the surface temperature of the work piece 2 to approximately the processing temperature. Then, the second flash light discharge lamps 10a into which the pulse current A with the short time width is inputted are turned on, and heats the work piece 2 for a short time by only part insufficient for heating it to the processing temperature. Since the two or more second flash light discharge lamps 10a are also arranged in the shape of a plane in parallel with the work piece 2, it is possible to emit flash light onto the work piece 2 uniformly, so as to raise the surface temperature of the work piece 2 to the processing temperature. Moreover, since the second flash light discharge lamps 10a are arranged so as to be closer to a side of the work piece 2 than the first flash light discharge lamps 10b, flash light emitted from the second flash light discharge lamps 10a is not blocked, so that it is possible to carry out irradiation efficiently and uniformly. When the two or more of the first flash light discharge lamps 10b are arranged in the shape of a plane in parallel with the work piece 2, and the two or more of the second flash light discharge lamps 10a are arranged in the shape of a plane in parallel with the work piece 2 so as to be closer to a side of the work piece 2 than the first flash light discharge lamps 10b, an irradiation energy distribution with a small ripple can be obtained.

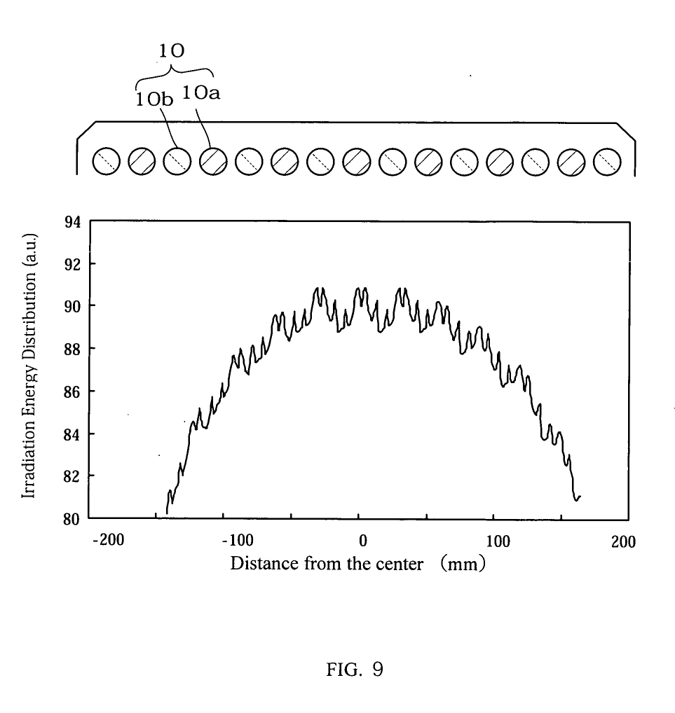

FIG. 9 is a diagram showing the irradiation energy distribution in case where the two or more of first flash light discharge lamps 10b into which the pulse current B with a long time width is inputted, and the two or more of the second flash light discharge lamps 10a into which the pulse current A with a short time width is inputted, are arranged by turns. The two or more first flash light discharge lamps 10b into which the pulse current B with a long time width shown in FIG. 6 is inputted, are arranged in the shape of a plane in parallel with the work piece 2 in which flash light is irradiated onto the work piece 2 thereby uniformly raising the temperature of the surface of the work piece 2 to approximately the processing temperature. Then, the second flash light discharge lamps 10a into which the pulse current A with a short time width is inputted are turned on in a period in which the pulse current B of the first flash light discharge lamps 10b decreases from its peak value to zero (0), so that the work piece 2 is heated for a short time by only part which is insufficient for the processing temperature of the work piece 2. Since the two or more of the second flash light discharge lamps 10a in which adjoining lamps are apart from each other by one flash light discharge lamp are arranged in the shape of a plane in parallel, spots tend to be produced in the irradiation energy applied to the work piece 2. As shown in FIG. 9, compared with the case where the two or more of the first flash light discharge lamps 10b as shown in FIG. 8 are arranged in the shape of a plane in parallel with the work piece 2, when the two or more of the first flash light discharge lamps 10b and the two or more of the second flash light discharge lamps 10a are arranged by turns, and the second flash light discharge lamps 10a are arranged in the shape of a plane in parallel with the work piece 2 so as to be closer to a side of the work piece 2 than the first flash light discharge lamps 10b, the irradiation energy distribution in which more ripple is produced is obtained. In addition, although embodiments are described referring to the cases where two or more of the flash light discharge lamps 10 are arranged, respectively as the first flash light discharge lamps 10b and the second flash light discharge lamps 10a, when the work piece 2 can be heated enough by one first flash discharge lamp 10b and one second flash discharge lamp 10a, it is possible to form the flash light emitting device 1 with the two flash light discharge lamps 10.

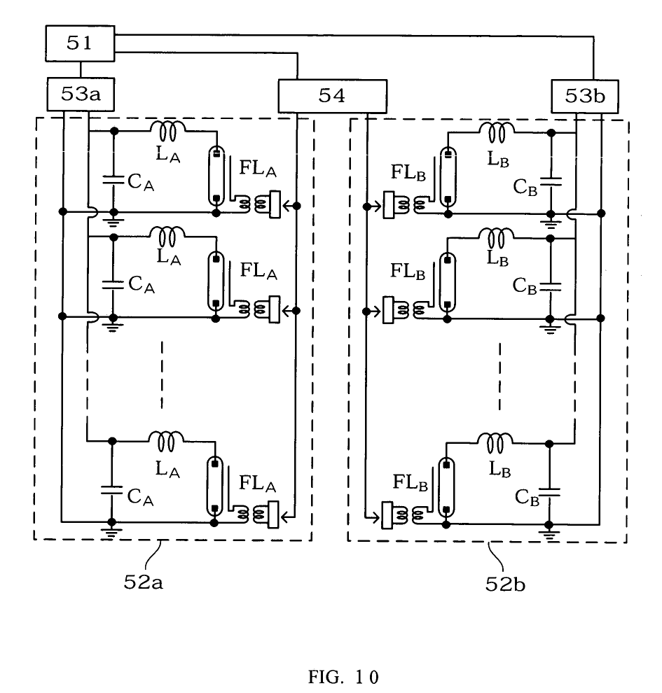

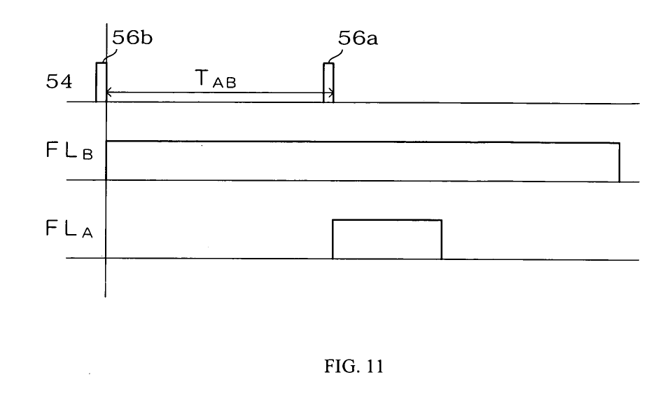

FIG. 10 is a diagram showing a lighting circuit in which first flash light discharge lamps FL_{B} and second flash light discharge lamps FL_{A} are separately turned on, and FIG. 11 is a timing chart of the lighting circuit shown in FIG. 10. The first flash light discharge lamps FL_{B} are turned on by a pulse current generating circuit 52b which generates pulse current B with a long time width, and the second flash light discharge lamps FL_{A} is turned on by a pulse current generating circuit 52a which generates pulse current A with a short time width. The capacity C_{A} and C_{B} of capacitors, inductances L_{A} and L_{B} of coils, charge voltage V_{A} and V_{B} of chargers 53, etc. are adjusted, so that the waveforms of the pulse current A and the pulse current B are determined. The time width of the pulse current A is preferably set to a range of from 0.001 to 1 msec, and the current density of its peak value to a range of from 1,200 to 5,100 A/cm². The time width of the pulse current B is preferably set to a range of from 0.3 to 500 msec, and the current density of its peak value to a range of from 600 to 5100 A/cm². However, the “current density of its peak value” represents a value which is obtained by dividing the peak value of the current waveform, by a cross section area of the inside of the electric discharge container 13, which is taken along approximately a discharge direction and a vertical direction of the electric discharge container 13.

Next, an operation of the lighting circuit shown in FIG. 10 is described, referring to FIG. 11. A lighting command signal is sent to a lighting signal generating section 54 from a control unit 51. When the lighting signal generating section 54 receives this signal, it sends a trigger generating signal 56b to trigger lines 16 connected to the pulse current generating circuit 52b, respectively, so that the first flash light discharge lamps FL_{B} are turned on. That is, when the pulse current generating circuit 52b which generates the pulse current B, generates trigger voltage thereby boosting the voltage by a boosting transformer after the pulse current generating circuit 52b receives the trigger generating signal 56b, high voltage is impressed to the trigger lines 16. This generates trigger electric discharge between the electrodes of each of the first flash light discharge lamps FL_{B}, so that the first flash light discharge lamps FL_{B} start electric discharge. Moreover, the lighting signal generating section 54 sends the trigger generating signal 56b to trigger lines 16 connected to the pulse current generating circuit 52a, respectively, which generates the pulse current A, and at the same time starts a timer circuit. After lighting delay time T_{AB}, the timer circuit sends a trigger generating signal 56a to the trigger lines 16 connected to the pulse current generating circuit 52a which generates the pulse current A, thereby turning on the second flash light discharge lamps FL_{A}. Thereby, it is possible to separately turn on the first flash light discharge lamps FL_{B} and the second flash light discharge lamps FL_{A}, so that the surface of the work piece 2 can be heated to the processing temperature or more for only a short time. In addition, the lighting delay time T_{AB} of the second flash light discharge lamps FL_{A} is beforehand determined from the waveforms of the pulse current A and the pulse current B, and the timer circuit is adjusted so that the delay time T_{AB} may be realized. After the first flash light discharge lamps FL_{B} and the second flash light discharge lamps FL_{A} are turned off, the control unit 51 sends a charge start signal to a charger 53a and a charger 53b and after they are fully charged, the control unit 51 sends a charge end signal thereto. After the charging operation of the charger 53a and the charger 53b is completed, the control unit 51 can turn on the first flash light discharge lamps FL_{B} and the second flash light discharge lamps FL_{A}, again by sending a lighting command signal to the lighting signal generating section 54 again.

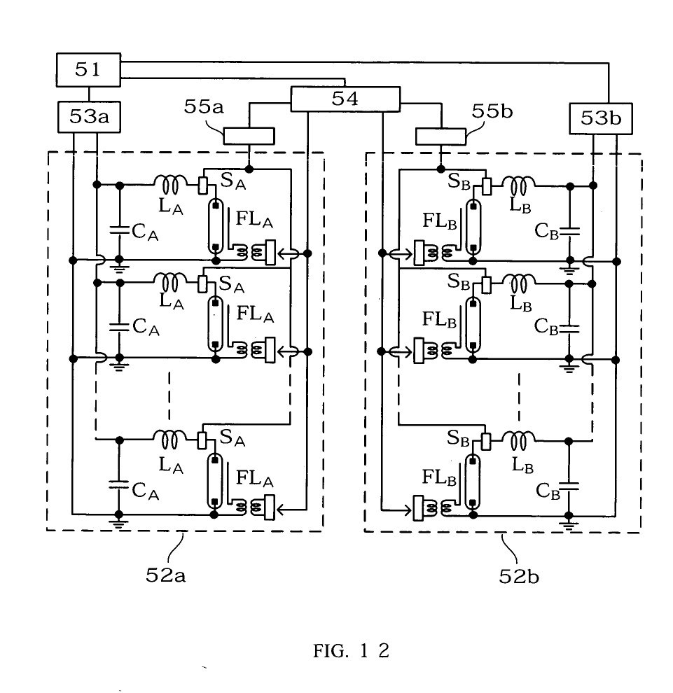

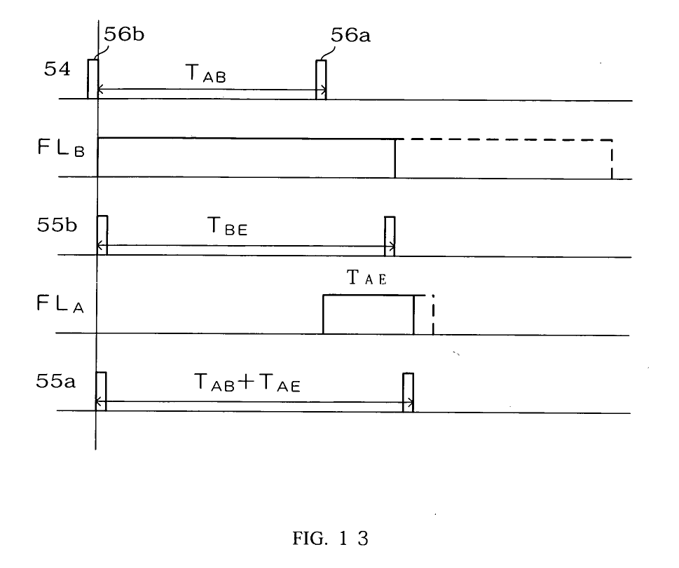

FIG. 12 is a diagram showing a lighting circuit which turns on first flash light discharge lamps FL_{B} and second flash light discharge lamps FL_{A}, while controlling pulse waveforms thereof by switches, and FIG. 13 is a timing chart of the lighting circuit shown in FIG. 12. The first flash light discharge lamps FL_{B} are turned on by a pulse current generating circuit 52b which generates pulse current B with a long time width, and the second flash light discharge lamps FL_{A} are turned on by a pulse current generating circuit 52a which generates pulse current A with a short time width. Here, the time width of the pulse current is controlled by an ON/OFF operation of the switches. Switching elements S_{A} and S_{B} are provided between coils L_{A} and the flash light discharge lamps FL_{A}, and coils L_{B} and the flash light discharge lamps FL_{B} respectively. It is possible to change the time width of the pulse current by turning off the switching elements S_{A} and S_{B} after a lapse of a predetermined time from time when the flash light discharge lamps are lighted, and stopping electric discharge of the flash light discharge lamps compulsorily. Here, before the pulse current B reaches its peak value, it is shut down compulsorily.

Next, an operation of the lighting circuit shown in FIG. 12 is explained referring to FIG. 13. A lighting command signal is sent to a lighting signal generating section 54 by a control unit 51, and when the lighting signal generating section 54 receives this signal, it sends a trigger generating signal 56b to the trigger line 16b connected to the pulse current generating circuit 52b which generates the pulse current B, thereby turning on the first flash light discharge lamps FL_{B}. Moreover, the lighting signal generating section 54 sends a trigger sending signal 56b, and, at the same time, sends a signal to the electric discharge control unit 55b, thereby starting a timer circuit of the electric discharge control unit 55b. The timer circuit of the electric discharge control unit 55b measures lighting time T_{BE} which is a period from time of lighting of the first flash light discharge lamps FL_{B} to time of turning off the lamps FL_{B}. The electric discharge control unit 55b turns off the switching elements S_{B} after a lapse of the lighting time T_{BE}, thereby stopping electric discharge of the first flash light discharge lamps FL_{B} compulsorily, so as to form pulse current B having a predetermined time width. Moreover, the lighting signal generating section 54 sends a trigger generating signal 56b to trigger lines 16 connected to the pulse current generating circuit 52b, respectively, which generates the pulse current B, and, at the same time, starts the timer circuit inside the lighting signal generating section 54. Furthermore, a signal is sent to an electric discharge control unit 55a, and a timer circuit of the electric discharge control unit 55a is started. The timer circuit of the electric discharge control unit 55a measures time T_{AB}+T_{AE} which is obtained by adding the lighting delay time T_{AB} of the second flash light discharge lamps FL_{A}, to time T_{AE} from lighting of the second flash light discharge lamps FL_{A} to turning off the lamps FL_{A}. The timer circuit of the lighting signal generating section 54 sends a trigger generating signal 56a to a trigger line 16a connected to the pulse current generating circuit 52a which generates pulse current A, after a lapse of the time T_{AB}, thereby turning on the second flash light discharge lamps FL_{A}. And, the electric discharge control unit 55a turns off the switching elements S_{A} after a lapse of the lighting time T_{AE}, and stops the electric discharge of the second flash light discharge lamps FL_{A} compulsorily, thereby generating the pulse current A having a predetermined time width. Thereby, it is possible to heat the surface of the work piece 2 to the processing temperature or more for only short time by separately tuning on the first flash light discharge lamps FL_{B} and the second flash light discharge lamps FL_{A}.

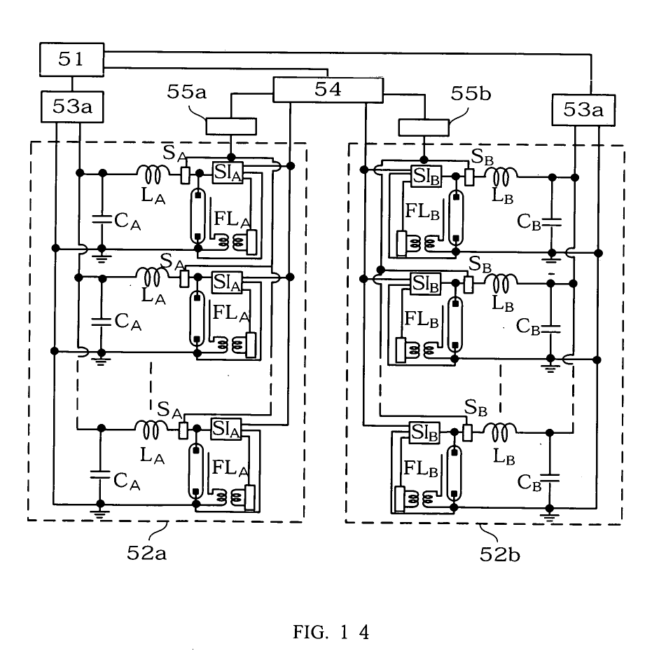

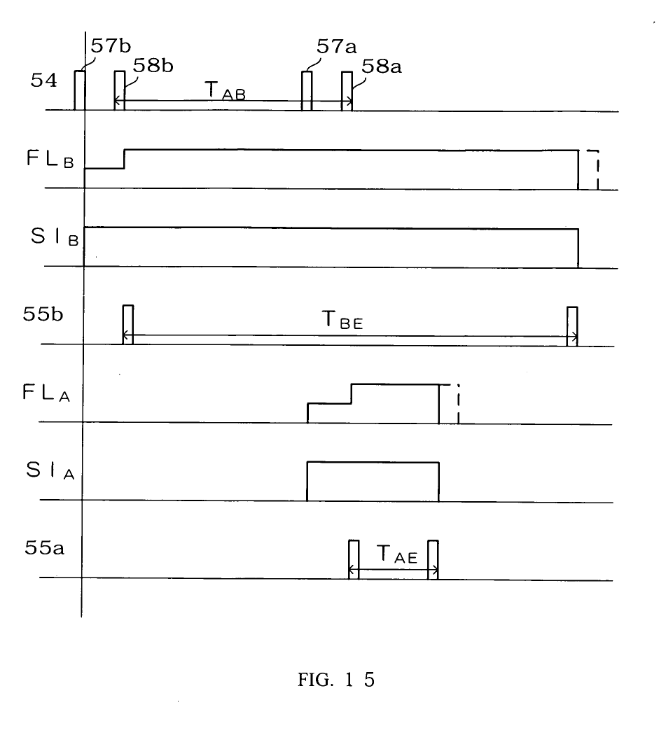

FIG. 14 is a diagram showing a lighting circuit which turns on first flash light discharge lamps FL_{B} and second flash light discharge lamps FL_{A} by a simmer electric discharge method, and FIG. 15 is a timing chart of the lighting circuit shown in FIG. 14. The first flash light discharge lamps FL_{B} are turned on by a pulse current generating circuit 52b which generates pulse current B with a long time width, and second flash light discharge lamps FL_{A} are turned on by a pulse current generating circuit 52a which generates pulse current A with a short time width. The simmer electric discharge method is a method capable of turning on the lamps at high speed by passing minute current therethrough even at non-lighting time. Moreover, in the simmmer electric discharge method, timing of a start and an end of electric discharge can be controlled by switching elements S_{A} and S_{B}. The lighting circuit shown in FIG. 12 can be converted into a simmer electric discharge system by adding on a circuit connected the lighting signal generating section 54 to the switching elements S_{A} and S_{B} through the simmer circuits SI_{A} and SI_{B} respectively. If the lighting signal generating section 54 receives a lighting command signal from the control unit 51, a simmer electric discharge lighting signal is sent to the simmer circuits SI_{A} and SI_{B}. When the simmer circuit receives the simmer electric discharge lighting signal, it starts simmer electric discharge. After the discharge is started, the switching elements S_{A} and S_{B} become an ON state, thereby starting main discharge, and then they become an OFF state, thereby terminating electric discharge. The simmer electric discharge continues even during a period of the main discharge, and if the switching elements S_{A} and S_{B} are turned off, the simmer discharge is ended. In addition, the main discharge can also be started again, without terminating the simmer electric discharge.

Next, an operation of the lighting circuit shown in FIG. 14 is explained, referring to FIG. 15. When a lighting command signal is sent to the lighting signal generating section 54 from the control unit 51, a simmer electric discharge lighting signal 57b is sent to the simmer circuits SI_{B} of the pulse current generating circuit 52b which generates the pulse current B. When the simmer circuits SI_{B} receive the simmer electric discharge lighting signal 57b, it starts simmer electric discharge. The main discharge lighting signal 58b is sent to the electric discharge control unit 55b from the lighting signal generating section 54 after the simmer discharge is started, and the electric discharge control unit 55b changes the switching elements S_{B} into an ON state, thereby turning on the first flash light discharge lamps FL_{B}. The electric discharge control unit 55b starts a timer circuit at the same time it changes the switching elements S_{B} into an ON state, and measures lighting time T_{BE} which is a period from time of lighting of the first flash light discharge lamps FL_{B} to time of turning off the lamps FL_{B}. The electric discharge control unit 55b turns off the switching elements S_{B} after a lapse of the lighting time T_{BE}, so as to stop electric discharge of the first flash light discharge lamps FL_{B} compulsorily, thereby generating the pulse current B having a predetermined time width. Moreover, the lighting signal generating section 54 starts the timer circuit inside the lighting signal generating section 54 at the same time it sends the main discharge lighting signal 58b to the electric discharge control unit 55b of the pulse current generating circuit 52b which generates the pulse current B. Before a lapse of the lighting delay time T_{AB} for the second flash light discharge lamps FL_{A}, the simmer electric discharge lighting signal 57b is sent to the simmer circuits SI_{B}, and the simmer electric discharge is started. And the lighting signal generating section 54 sends the main discharge lighting signal 58a to the electric discharge control unit 55a after a lapse of the lighting delay time T_{AB} for the second flash light discharge lamps FL_{A}, so that the electric discharge control unit 55a changes the switching element S_{A} into an ON state, thereby turning on the second flash light discharge lamps FL_{A}. The electric discharge control unit 55a starts a timer circuit at the same time it changes the switching elements S_{A} into an ON state, and measures the lighting time T_{AE} from time of lighting of the second flash discharge lamps FL_{A} to time of turning of the lamps FL_{A}. The electric discharge control unit 55a turns off the switching elements S_{A} after a lapse of lighting time T_{AE}, so as to stop electric discharge of the second flash light discharge lamps FL_{A} compulsorily, thereby generating the pulse current A with a predetermined time width. Thereby, it is possible to heat the work piece 2 to the processing temperature or more for only a short time, thereby exposing minute circuits thereon by separately turning on the first flash light discharge lamps FL_{B} and the second flash light discharge lamps FL_{A}. Then, detailed embodiments will be described below.

### EXAMPLE 1

An embodiment of a case where a silicon wafer is used as a work piece is shown. The structure of this flash light discharge device is described below. Twenty nine (29) first flash light discharge lamps having an electric discharge container with a 10 mm inside diameter and a 500 mm light emission length, were arranged in parallel to one another, and thirty (30) second flash light discharge lamps having an electric discharge container with a 10 mm inside diameter and a 500 mm light emission length, were arranged in parallel to one another in a side of the work piece. The work piece was beforehand heated so that the surface temperature became 500 degrees Celsius by a preheating unit, and a time width of the pulse current of the first flash light discharge lamps was set to 0.7 msec, and a time width of the pulse current of the second flash light discharge lamps was set to 0.1 msec. It was examined at what timing the lighting of the second flash light discharge lamp should be started, to study whether the work piece can be activated with the pulse current having the peak value smaller than that in the case where fifty nine (59) flash light discharge lamps in which the time width of pulse current was set to 0.1 msec, were arranged. However, as the activation achievement condition, the work piece was set to below 400 Ω/□ (ohms/Square). The unit Ω/□ represents a sheet resistance. This was the activation condition for a 12 inch silicon wafer in which impurities of the quantity of 5×10¹⁵ cm⁻² are introduced into silicon at acceleration voltage 40 keV. Moreover, irradiation energy was measured using a calorie meter. Consequently, when the second flash light discharge lamps into which the pulse current A with a short time width was inputted were turned on during a period in which the pulse current B of the first flash light discharge lamps decreased from its peak value to zero (0), the work piece could be activated with the pulse current with its peak value smaller than that in the case where the work piece was activated only by the flash light discharge lamps in which the time width of pulse current was 0.1 msec. This is because the surface of the work piece was raised to approximately the processing temperature by the first flash light discharge lamps, and then the second flash light discharge lamps were turned on so as to rise the surface temperature of the work piece to the processing temperature. When the second flash light discharge lamps were turned on until the pulse current B of the first flash light discharge lamps decreased from its peak value to 60% of the peak value, that is, in a time range of 0.6 to 0.9 msec after time of inputting current, even if the lamps were lighted tens of thousands times or more so as to satisfy the processing achievement conditions, degradation of an electric discharge container did not occur, but the life span of the flash light discharge lamps could be extended.

### EXAMPLE 2

A case where the work piece was heated by the flash light discharge lamps into which single pulse current was inputted as a comparative example of embodiment 1 is described below. The structure of the flash light discharge device is described below. Fifty nine (59) flash light discharge lamps each of which had an electric discharge container with a 10 mm inside diameter and a 500 mm light emission length, were simultaneously turned on, with a single pulse current whose time width was 0.05, 0.1, 0.3, 0.5, 0.7, 1.0 and 5.0, and 50 msec, respectively. Consequently, when these lamps were turned on with the pulse current having the time width of 0.3 or less msec so as to satisfy the processing achievement condition, after these lamps were lighted hundreds to a couple of thousand times, the surface of the electric discharge containers of the flash light discharge lamps were deteriorated remarkably, so that the illuminance decreased remarkably. When the amount of energy of a single pulse current was secured so that the work piece could be heated to the predetermined temperature, the current density of the peak value of the pulse current became 5,100 A/cm² in case where the time width of current was 0.3 msec. When the time width of pulse current was 0.2 msec, the current density of the peak value of the pulse current became 5,700 A/cm², and when the time width of the pulse current was 0.05 msec, the current density of the peak value of the pulse current became 8,900 A/cm². This is because since the current density of the peak value of the pulse current became 5,100 A/cm² or more, the temperature of the electric discharge container became too high, so as to exceed a heat-resistant temperature thereof, thereby deteriorating the surface thereof remarkably.

### EXAMPLE 3

A flash light discharge device similar to that of Example 1 was used, but was different therefrom, in that the pulse current with a time width of 1, 1.5, 2, 3, 5, 10, and 20 msec was inputted in the first flash light discharge lamps, and the pulse current of the time width of 1 msec was inputted into the second flash light discharge lamps. When the pulse current B of the first flash light discharge lamps decreased from its peak value to 80% of the peak value, the lamps were turned on so that the pulse current A of the second flash light discharge lamps was the peak value after 0.2, 0.8, 1.4, 2.6, 5 and 11, and 23 msec from the input, respectively. Under the condition, the 100 work pieces were heated, and it was examined whether the work pieces would broke up. This experimental result is shown in Table 1.

TABLE 1

| The width of pulse current B | The number of broken work |
|---|---|
| (msec) | pieces |
| 1 | 10 |
| 1.5 | 7 |
| 2 | 1 |
| 3 | 1 |
| 5 | 1 |
| 10 | 1 |
| 20 | 1 |

If the first flash light discharge lamps into which the pulse current whose time width was 1 msec was inputted, were lighted, while superimposing light from the second flash light discharge lamps into which pulse current whose time width was 1 msec was inputted, although, as in the conventional flash light discharge device, the work piece 2 was heated to the processing temperature for approximately 1 msec, the frequency at which the work piece broke up, decreased. When the time width of the pulse current of the second flash light discharge lamps were more than twice as long as that of the first flash light discharge lamps, i.e., the pulse current of the pulse current was 2 msec or more, it was confirmed that the frequency at which the work piece broke up became 1/10 of that of the conventional flash light discharge device. In addition, when the pulse current having the time width of 1 msec was inputted into the first flash light discharge lamps, and the pulse current having a time width of 1 msec or less was inputted into the second flash light discharge lamps, the frequency at which the work piece broke up was approximately the same as that in case where pulse current having time width of 1 msec was inputted into both the first flash light discharge lamps and the second flash light discharge lamps. It was confirmed that the flash light emitting device was practical, since the crack frequency of the work piece was approximately the same as that of the conventional flash light discharge device.

The preceding description has been presented only to illustrate and describe exemplary embodiments of the flash light emitting device according to the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A flash light emitting device that irradiates flash light to a work piece, comprising:
a first flash light discharge lamp and a second flash light discharge lamp,
wherein a time width of a second flash light discharge lamp current is shorter than a time width of a first flash light discharge lamp current, and the second flash light discharge lamp current is inputted into the second flash light discharge lamp after the first flash light discharge lamp current is inputted into the first flash light discharge lamp.

2. The flash light emitting device according to claim 1, wherein a peak value of the second flash light discharge lamp current exists in a period in which the first flash light discharge lamp current decreases from a peak value thereof to zero.

3. The flash light emitting device according to claim 1, wherein the first flash light discharge lamp current is shut down compulsorily, and the second flash light discharge lamp current is inputted before the first flash light lamp current turns into zero.

4. The flash light emitting device according to claim 1, wherein the first flash light discharge lamp current is shut down compulsorily by a switching element.

5. The flash light emitting device according to claim 4, wherein a first pulse of the second flash light discharge lamp current is inputted before the first flash light discharge lamp current is shut down, so that the first pulse of the second flash light discharge current reaches a peak value thereof before the pulse current B is shut down, a second pulse of the second flash light discharge lamp current being inputted approximately at time of shut down of the first flash light discharge lamp current, so that timing of a peak value of the second pulse of the second flash light discharge lamp current and that of a peak value of the pulse current are matched each other, and a third pulse of the second flash light discharge lamp current beginning immediately after the shut down of the first flash light discharge current, so that the third pulse of the second flash light discharge lamp current reaches a peak value thereof after the shut down of the first flash light discharge lamp current.

6. The flash light emitting device according to claim 1, wherein two or more of the first flash light discharge lamps are arranged in a shape of plane, and two or more of the second flash light discharge lamps are arranged in a shape of plane between the first flash light discharge lamps and the work piece.

7. The flash light emitting device according to claim 1, further including a preheating unit.

8. The flash light emitting device according to claim 1, wherein a time width of the first flash light discharge lamp current is 0.3 to 500 msec.

9. The flash light emitting device according to claim 8, wherein current density of a peak value of the first flash light discharge lamp current is 600 to 5100 A/cm².

10. The flash light emitting device according to claim 9, wherein a time width of the second flash light discharge lamp current is 0.001 to 1.0 msec

11. The flash light emitting device according to claim 10, wherein current density of a peak value of the first flash light discharge lamp current is 1,200 to 5,100 A/cm².

12. The flash light emitting device according to claim 1, further including a simmer circuit.

13. A flash light emitting device that irradiates flash light to a work piece, comprising:
two or more first flash light discharge lamps which are provided above the work piece; and
two or more second flash light discharge lamps which are provided above the work piece,
wherein a time width of a second flash light discharge lamp current is shorter than that of a first flash light discharge lamp current, and the second flash light discharge lamp current is inputted into the second flash light discharge lamps after the first flash light discharge lamp current is inputted into the first flash light discharge lamps.

14. The flash light emitting device according to claim 13, wherein the first flash light discharge lamps and the second flash light discharge lamps are provided by turns.

15. The flash light emitting device according to claim 14, wherein a distance from the second flash light discharge lamps to the work piece is shorter than that from the first flash light discharge lamps to the work piece.
